(19) United States
(12) Patent Application Publication
(10) Pub. No.: US 2007/0217181 A1
(43) Pub. Date: Sep. 20, 2007

(54) LIGHT GUIDE FOR ILLUMINATING KEYPADS

(75) Inventors: CHIEN-AN CHIU, Shenzhen (CN); KUO-CHU CHANG, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,485

(22) Filed: Aug. 11, 2006

(30) Foreign Application Priority Data
Mar. 17, 2006 (TW) 95204475

(51) Int. Cl. G01D 11/28

(52) U.S. Cl. 362/26

(57) ABSTRACT

A light guide (30) for illuminating a keypad (20) including a plurality of keys (22) includes a plurality of apertures (300) corresponding to the keys, and a plurality of projecting portions (340). The projecting portions protrude from a face of the light guide away from the keypad.

### CROSS-REFERENCE TO RELATED APPLICATION

This present application is related to two co-pending U.S. patent applications entitled “LIGHT GUIDE FOR ILLUMINATING KEYPADS,” recently filed with Attorney Docket Nos. US9499 and US9503, and assigned to the same assignee as that of the present application.

### 1. FIELD OF THE INVENTION

The invention relates to light guides, and particularly to a light guide for illuminating a keypad or keyboard uniformly.

### 2. DESCRIPTION OF RELATED ART

It is common to illuminate a keypad or keyboard of an electronic device, such as a mobile telephone, to facilitate nighttime use. Each individual key may be illuminated by a respective light source located directly behind the key. This arrangement is, however, very expensive since a separate light source is required for each key. Furthermore, the power dissipation of the mobile telephone is increased, and the standby time of the mobile telephone is shorter.

A more economical approach utilizes fewer distributed light sources and the light is directed towards the keys with the aid of a light guide in the form of a transparent plate. Referring to FIG. 5, a plan view of a conventional light guide 50 is shown. The light guide 50 comprises a plurality of V-shaped notches 52 defined at a periphery thereof, and an array of apertures 520 arranged in four rows and three columns. The apertures 520 are rectangular with rounded corners, corresponding to keys 60 of a keypad. Four light sources, such as light-emitting diodes, are located behind the light guide 50. In a vicinity of each of the light sources, the light guide 50 comprises a respective convex lens 70 formed integrally therewith. Aligned with the lens 70, adjacent to a front face of the light guide 50, there is provided a prismatic indentation 72, which offers four reflecting surfaces each having a triangular outline. The light from the light source is collimated by the lens 70 into a beam traveling transversely into the light guide 50, then the prismatic indentation 72 serves to direct the beam into a plane of the light guide 50 by means of total internal reflection to illuminate the keys 60. However the number of the light sources is four, and the power dissipation of the mobile telephone is still too great. In addition, the illumination is not uniform as the brightness of the keys 60 adjacent to the light source is greater than that of the keys 60 away from the light source, and the cost of manufacturing the light guide 50 is greater because the lens 70 is formed integrally with the light guide 50.

Therefore, a heretofore unaddressed need exists in the industry to overcome the aforementioned deficiencies and inadequacies.

### SUMMARY OF THE INVENTION

An aspect of the invention provides a light guide for illuminating a keypad including a plurality of keys. The light guide includes a plurality of apertures corresponding to the keys, and a plurality of projecting portions. The projecting portions protrude from a face of the light guide away from the keypad.

Another aspect of the invention provides an electronic device. The electronic device includes a keypad, a light guide disposed under the keypad, and at least one light source. The keypad includes a plurality of keys. The light guide includes a plurality of apertures corresponding to the keys, at least one receiving hole defined in an end thereof, and a plurality of projecting portions protruding therefrom. Density of the projecting portions increases along a direction away from the at least one receiving hole. The at least one light source is received in the at least one receiving hole of the light guide.

Other advantages and novel features will become more apparent from the following detailed description of preferred embodiments when taken in conjunction with the accompanying drawings, in which:

### BRIEF DESCRIPTION OF THE DRAWINGS

FIG. 1 is an exploded, isometric view of an electronic device of an exemplary embodiment of the present invention, the electronic device comprising a keypad and a light guide;

FIG. 2 is an enlarged, inverted, isometric view of the light guide of FIG. 1;

FIG. 3 is an enlarged view of a circled portion III of FIG. 2;

FIG. 4 is a schematic diagram of light reflecting in the light guide of FIG. 1; and

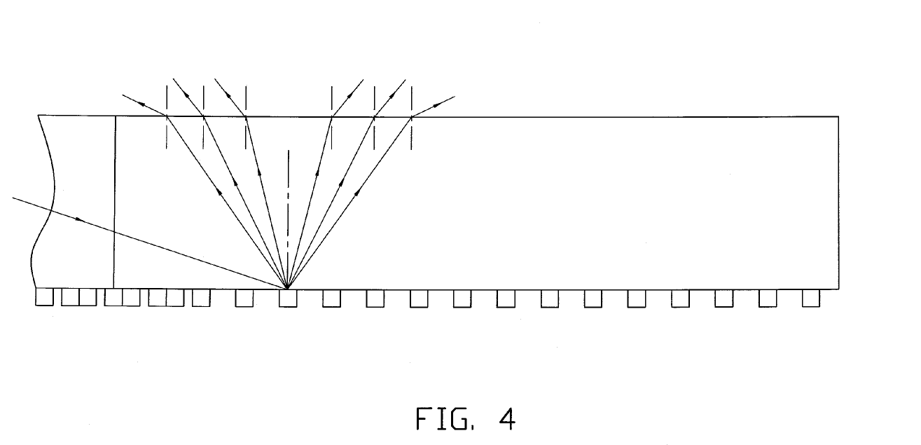

FIG. 5 is a plan view of a conventional light guide.

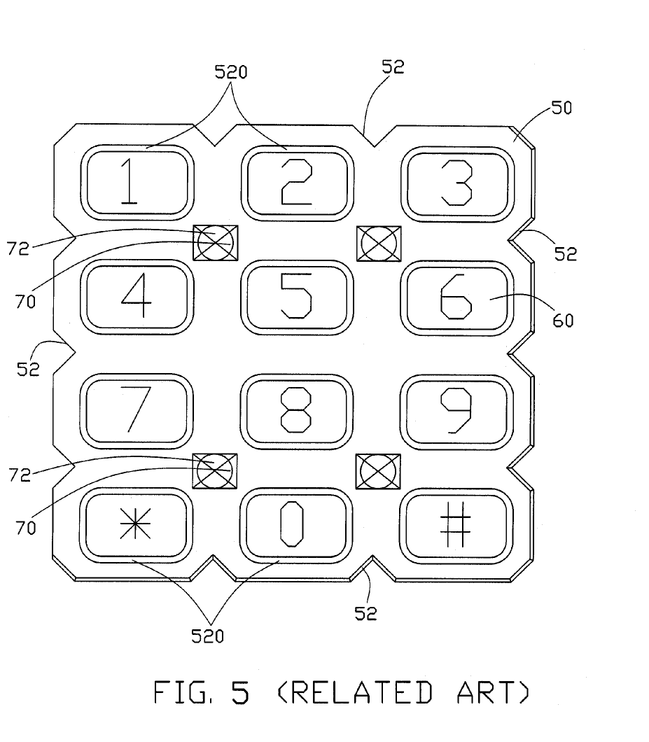

### DETAILED DESCRIPTION OF THE INVENTION

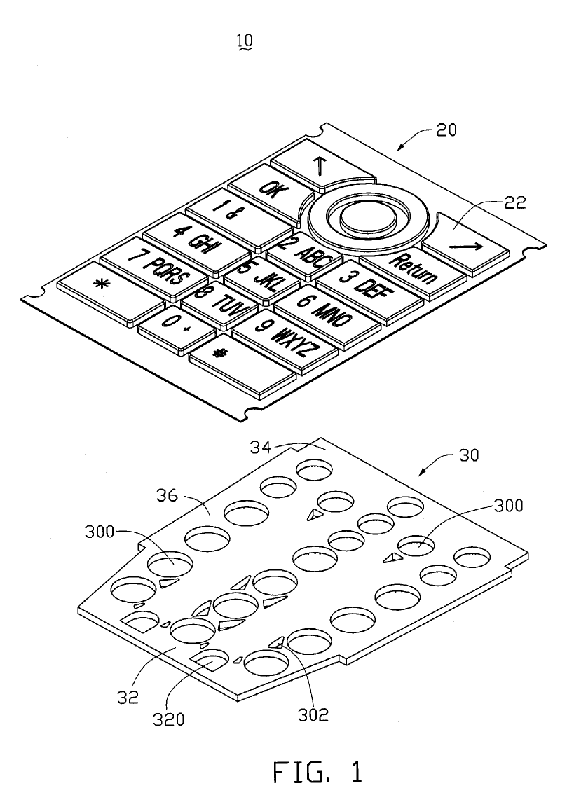

Referring to FIG. 1, an electronic device 10 of an exemplary embodiment of the present invention is shown. The electronic device 10 comprises a keyboard 20 and a light guide 30.

The keypad 20 has a generally rectangular profile. The keypad 20 comprises a plurality of keys 22.

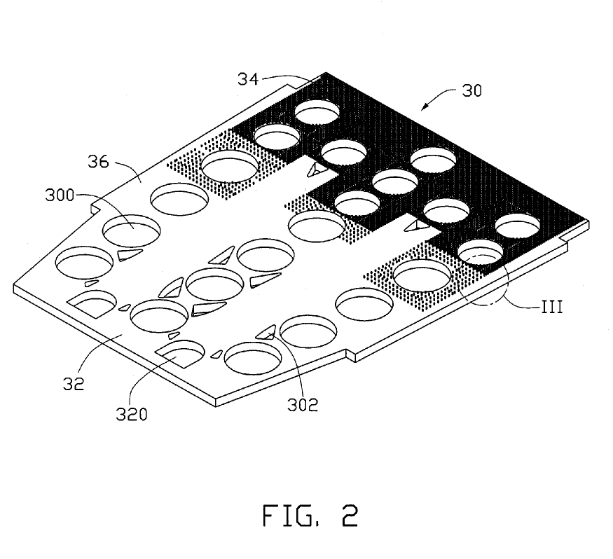

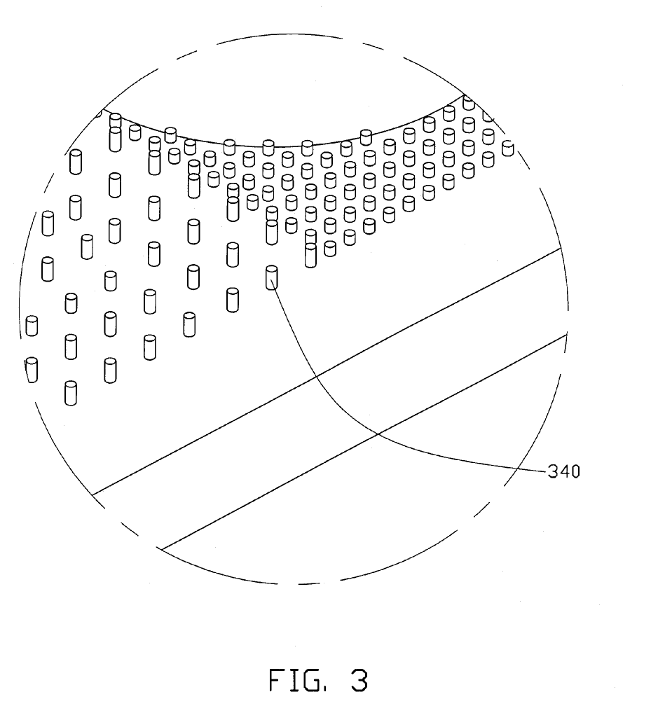

Referring also to FIGS. 1-3, the light guide 30 can be mounted on a circuit board comprising a pair of light sources, for example, two light-emitting diodes (not shown). The light guide 30 is a transparent plate. The light guide 30 comprises a first end portion 32, a second end portion 34 opposite to the first end portion 32, and a middle portion 36 connecting the first end portion 32 with the second end portion 34. A pair of spaced receiving holes 320 is defined in an end of the first end portion 32 away from the middle portion 36, for receiving the light sources. The light guide 30 further comprises a plurality of projecting portions 340 protruding from the second end portion 34 and the middle portion 36. The projecting portions 340 are away from the keypad 20. The projecting portions 340 absorb light from the light sources, and then diffuse the light within the light guide 30. Meanwhile, the projecting portions 340 prevent total reflection, thereby the light is uniformly thrown from a surface of the light guide 30 adjacent to the keypad 20. In the exemplary embodiment, the projecting portions 340 are made of print material comprising Silicon Dioxide (SiO2) and Titanium Dioxide (TiO2). A diameter of each projecting portion 340 arranged on the middle portion 36 is slightly greater than that of each projecting portion 340 arranged on the second portion 34. A distance between every two adjacent projecting portions 340 arranged on the middle portion 36 is slightly greater than that between every two adjacent projecting portions 340 arranged on the second portion 34. In this way, density of the projecting portions 340 arranged on the middle portion 36 is less than that of the projecting portions 340 arranged on the second portion 34.

The light guide 30 comprises a plurality of apertures 300 corresponding to the keys 22 of the keypad 20. The apertures 300 are generally positioned in three columns. One of the columns of the apertures 300 is positioned in a lengthwise central line of the light guide 30. The receiving holes 320 are symmetrically positioned to either side of an end of the central column of the apertures 300 in the first end portion 32. The light guide 30 further comprises two apertures 300 defined in the second end portion 34 and respectively positioned in the same lengthwise lines as the receiving holes 320. Thus, the keys 22 of the keypad 20 are positioned in an illumination range of 120° corresponding to that of the light sources. In the exemplary embodiment, the light sources are light-emitting diodes. A preferred illumination range within which power of illumination from the light-emitting diode is greatest is 120° centered about an axis of each receiving hole 320. Thus, at least one portion of each key 22 of the keypad 20 is positioned in the illumination range of 120° corresponding to that of the light sources.

The light guide 30 also comprises a plurality of holes 302. Some of the holes 302 are disposed near the apertures 300 adjacent to the receiving holes 320, and two of the holes 302 are positioned in the same lengthwise line as the receiving holes 320. That is, the holes 302 are disposed near the keys 22 where illumination is greatest. Each hole 302 is triangular shaped. Thereby, the light from the light sources illuminates the keypad 20 uniformly.

In assembly, the keys 22 of the keypad 20 are received in the apertures 300 of the light guide 30, respectively, thereby the keypad 20 and the light guide 30 are mounted together.

In use, the light from the light sources received in the receiving holes 320 is introduced into the light guide 30, and reflects within the light guide 30. Because the projecting portions 340 are arranged on the second end portion 34 and the middle portions 36, and the light sources being received in the receiving holes 320 of the first end portion 32 having no the projecting portions 340, the number of reflections that the light reflects within the first end portion 32 is less than that of the second portion 34 and the middle portion 36. Meanwhile, because the density of the projecting portions 340 arranged on the second portion 34 is less than that of the projecting portions 340 arranged on the middle portion 36, the number of reflections that the light reflects within the middle portion 36 is less than that of the second portion 34. In this way, the loss of illuminating power as the light travels through the light guide 30 is compensated for by the increase in density of the number of reflections over distance. Thus, a brightness of the portion of the light guide 30 away from the light sources is comparable to a brightness of the portion of the light guide 30 near the light source, so that a uniform brightness is obtained. Furthermore, the number of the light sources used in the electronic device 10 is reduced, and the standby time of the electronic device 10 is prolonged.

In an alternative embodiment, the projecting portions 340 may be defined in the first end portion 32, the middle portion 36 and the second end portion 34. Density of the projecting portions 340 reduces gradually from the first end portion 32 to the second end portion 34. Alternatively, density of the projecting portions 340 arranged on the middle portion 36 may be slightly greater than that of the projecting portions 340 arranged on the first end portion 32, but less than that of the projecting portions 340 arranged on the second end portion 34.

While exemplary embodiments have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. A light guide for illuminating a keypad, wherein the keypad includes a plurality of keys, the light guide comprising:
a plurality of apertures, corresponding to the keys; and
a plurality of projecting portions protruding from a face thereof away from the keypad.

2. The light guide as claimed in claim 1, further comprising at least one receiving hole defined in an end thereof, for receiving at least one light source.

3. The light guide as claimed in claim 2, wherein density of the projecting portions increases along a direction that is away from the at least one receiving hole.

4. The light guide as claimed in claim 2, wherein diameters of the projecting portions reduce along a direction away from the at least one receiving hole.

5. The light guide as claimed in claim 2, wherein a distance between every two adjacent projecting portions reduces along a direction away from the at least one receiving hole.

6. The light guide as claimed in claim 2, wherein the apertures are generally disposed within an illumination range of 120 degrees centered about an axis of the at least one light source.

7. The light guide as claimed in claim 6, further comprising a first end portion, a second end portion opposite to the first end portion, and a middle portion connecting the first end portion and the second end portion.

8. The light guide as claimed in claim 7, wherein the projecting portions are arranged on the middle portion and the second portion.

9. The light guide as claimed in claim 8, wherein a diameter of each of the projecting portions arranged on the middle portion is slightly greater than that of each of the projecting portions arranged on the second end portion.

10. The light guide as claimed in claim 8, wherein a distance between every two adjacent projecting portions arranged on the middle portion is slightly greater than that between every two adjacent projecting portions arranged on the second end portion.

11. An electronic device, comprising:
a keypad comprising a plurality of keys;
a light guide disposed under the keypad, the light guide comprising a plurality of apertures corresponding to the keys, at least one receiving hole defined in an end thereof, and a plurality of projecting portions protruding therefrom, density of the projecting portions increasing along a direction away from the at least one receiving hole; and
at least one light source received in the at least one receiving hole of the light guide.

12. The electronic device as claimed in claim 11, wherein diameters of the projecting portions reduce along said direction.

13. The electronic device as claimed in claim 11, wherein a distance between every two adjacent projecting portions reduces along said direction.

14. The electronic device as claimed in claim 11, wherein the apertures are generally disposed within an illumination range of 120 degrees centered about an axis of the at least one light source.

15. The electronic device as claimed in claim 11, wherein the light guide comprises a first end portion, a second end portion opposite to the first end portion, and a middle portion connecting the first end portion and the second end portion.

16. The electronic device as claimed in claim 15, wherein the projecting portions are arranged on the middle portion and the second end portion.

17. The electronic device as claimed in claim 16, wherein a diameter of each of the projecting portions arranged on the middle portion is slightly greater than that of each of the projecting portions arranged on the second end portion.

18. The electronic device as claimed in claim 16, wherein a distance between every two adjacent projecting portions arranged on the middle portion is slightly greater than that between every two adjacent projecting portions arranged on the second end portion.

19. An electronic device comprising:
a keypad comprising a plurality of keys installably extending along a side of said electronic device;
a light source installable in said electronic device for illuminating said plurality of keys of said keypad; and
a light guide installable in said electronic device beside said light source and said keypad, respectively, to transmit light from said light source toward said keypad through said light guide, said light guide comprising a first surface facing said light source to receive said light from said light source into said light guide, a second surface facing said keypad to transmit said light out of said light guide toward said keypad and a third surface opposite to said second surface, a plurality of projecting portions protruding from said third surface away from said second surface, and said plurality of projecting portions being denser and size-smaller when said plurality of projecting portions is arranged at said third surface farther away from said first surface.
